(19) United States
(12) Patent Application Publication
(10) Pub. No.: US 2016/0264338 A1
(43) Pub. Date: Sep. 15, 2016

(54) REUSABLE MODIFIED ATMOSPHERIC PACKAGING

(71) Applicant: Gary Dean Growden, Apple Valley, MN (US)

(72) Inventor: Gary Dean Growden, Apple Valley, MN (US)

(21) Appl. No.: 15/065,285

(22) Filed: Mar. 9, 2016

Related U.S. Application Data
(60) Provisional application No. 62/129,962, filed on Mar. 9, 2015.
(60) Provisional application No. 62/129,963, filed on Mar. 9, 2015.

(51) Int. Cl. B65D 81/20; B65D 33/25; G10G 7/00; B65D 85/50; A24F 23/00; B65D 41/04; B65D 85/18

(52) U.S. Cl. CPC B65D 81/2069; B65D 41/04; B65D 33/25; B65D 85/18; B65D 85/50; A24F 23/00; G10G 7/00

(57) ABSTRACT

A reusable modified atmosphere packaging system, including a package having a plurality of walls that define an interior space and an opening, an exterior space circumscribing the package, the exterior space being selectively joinable with the interior space, a closure selectively separating the interior space from the exterior space, atmospheric gases positioned in the interior space, an exit port extending from the interior space to the exterior space, an entrance port extending from the exterior space to the interior space, the entrance port being a one-way valve, product positioned in the interior space within the atmospheric gases, and a modified atmosphere source containing modified atmospheric gases, the modified atmosphere source selectively sealable through the entrance port, the modified atmospheric gases selectively in fluid communication with the interior space.

### CROSS REFERENCE TO RELATED APPLICATIONS

This application claims benefit of U.S. Provisional Application No. 62/129,962, filed Mar. 9, 2015 and U.S. Provisional Application No. 62/129,963, filed on Mar. 9, 2015.

### FIELD OF THE INVENTION

The present invention relates to modified atmospheric packaging and more particularly packaging where the modified atmosphere can be repeatedly reapplied.

### BACKGROUND OF THE INVENTION

Innovators have long sought to preserve parishable product, particularly foodstuffs, flowers, and instruments and many other items. Nobody wants to eat stale potato chips or have mold growing on their favorite steaks and vegetables. This has led to a wide variety of solutions.

One such technology is called “modified atmosphere packaging.” Modified atmosphere packaging, MAP, involves an atmosphere differing from normal air. Normally, the oxygen content is reduced and the carbon dioxide and/or nitrogen content is increased, which reduces the oxygen available to aerobic and other organisms. MAP can involve controlling humidity or other atmospheric components.

Five main groups of machines provide modified atmospheric packaging, using either gas flushing or vacuum extraction with gas injection.

The “Horizontal Flow Pack” produces a continuous tube flushed with map gas. Product is placed in the tube and the tube is sealed on both sides of each product and separated from the other packaged product in the same tube. This packaging is single use at the packager's facility.

The “Vertical Flow Pack” operates similar to the horizontal flow pack, but is vertically oriented and used for powdered and bulk products such as coffee and peanuts. This packaging is single use at the packager's facility.

“Deep Drawing Machine” uses a tray, which holds the product. Air is removed with a vacuum and a film overlies the tray. MAP gas is injected and the film is heat sealed to the tray. This packaging is single use at the packager's facility.

A “Vacuum Chamber Machine” places packages in a chamber from which the air is removed. MAP gas is injected to equalize the pressure and the package is heat sealed. This packaging is single use at the packager's facility.

A “Bag Sealing Machine Bag-In-A-Box” uses a snorkel to remove the air. MAP gas is fed in and the snorkel removed. Then the bag is heat welded to seal in the MAP gas. This packaging is single use at the packager's facility.

Some examples of inventive constructs are found in the patent literature: Myers (U.S. Pat. No. 4,515,266) in the patent, entitled Modified Atmosphere Package and Process, teaches a package for preserving produce in a wholesome condition for an extended period of time is formed by a sealed container enveloping the produce and filled with a preservative gas which inhibits bacterial growth.

DelDuca, et al. (U.S. Pat. No. 6,183,790) provides a different option. DelDuca, et al. use a modified atmosphere packaging method that creates a modified atmosphere in a package including an inner package and an outer package. After a food product such as raw meat is placed within the inner package, the inner package is flushed with a desired mixture of gases to substantially remove oxygen from the inner package. The flushed inner package is then sealed and inserted into the outer package without sealing the outer package. Next, the outer package is flushed with the desired mixture of gases to substantially remove oxygen from the outer package. After flushing the outer package, the outer package is sealed.

Koenck et al. (U.S. Pat. No. 7,154,103) teaches a method of providing extended shelf life fresh meat products involving irradiating the meat products in a first controlled atmosphere and packaging the irradiated meat products in a second controlled atmosphere. The packaged irradiated meat products are then distributed to a retail store.

The five aforemention machine types and Meyers, DelDuca and Koenck are excellent solutions for companies in the business of packaging food for resale. However, they fail to explain what should be done once the consumer opens the container. Regular atmospheric gas, oxygenated, mixes with and destroys the modified atmosphere. This allows bacterial growth to resume at normal speed.

The consumer needs a MAP package that they can use over and over. The consumer should be able to re-modify the atmosphere each time they open the container. Re-modifying greatly extends the shelf-life. Instead of merely extending the time from the producer to the consumer, the shelf life is extended from the producer until the food, or other product, is actually consumed!

### SUMMARY OF THE INVENTION

The present invention is a reusable modified atmosphere packaging system. The system may include a package, a closure, atmospheric gases, an exit port, an entrance port, product and a modified atmosphere source.

The package may have a plurality of walls that define an interior space, an exterior space and an opening. The exterior space circumscribes the package, while the interior space is inside the package. The exterior space may be selectively joinable with the interior space. The closure may selectively separate the interior space from the exterior space. Atmospheric gases may be selectively positioned in the interior space.

The entrance and exit ports may extend from the interior space to the exterior space. The entrance port desirably is a one-way valve.

Product may be positioned in the interior space. Product, for instance, may include food, flowers, musical instruments, tobacco, paint and more.

The modified atmosphere source may contain modified atmospheric gases and may be selectively sealable through the entrance port. The modified atmospheric gases may selectively be in fluid communication with the interior space.

Advantageously, the present package employs modified atmosphere packaging, which provides for greatly enhanced shelf life of product minimizing the growth and development of aerobic organisms or other degradation of product.

Beneficially, the present invention is structured to repeatedly restore the modified atmosphere inside the package each and everytime the package is opened.

Also of benefit, the package is structured to prevent escape of the modified atmosphere unless the user wishes to access the product.

As further benefit, the package can be used and re-used with many different types of products.

Also advantageously, the present invention can convert non-reusuable MAP packages into re-usable MAP packages.

These and other benefits and advantages are clearly explained below.

### DESCRIPTION OF THE DRAWINGS

FIG. 1 shows a perspective view of a first embodiment of the present invention;

FIG. 2 is an exploded perspective view of the entrance port of the present invention;

FIG. 3 is a perspective view of the outer member;

FIG. 4 is a perspective view of a clip which may be used to secure the package opening of the first embodiment;

FIG. 5 is a perspective view of a second embodiment of the present invention;

FIG. 6 is a partially exploded perspective view partially in phantom showing a third embodiment of the present invention;

FIG. 7 is a top view of the lid of the third embodiment;

FIG. 8 is an exploded partial view with a cap shown in cross section of the fourth embodiment of the present invention; and

FIG. 9 is an assembled view of the fourth embodiment of the present invention.

These figures show the preferred embodiment of the present invention and are not to be considered limiting of the invention.

### DETAILED DESCRIPTION

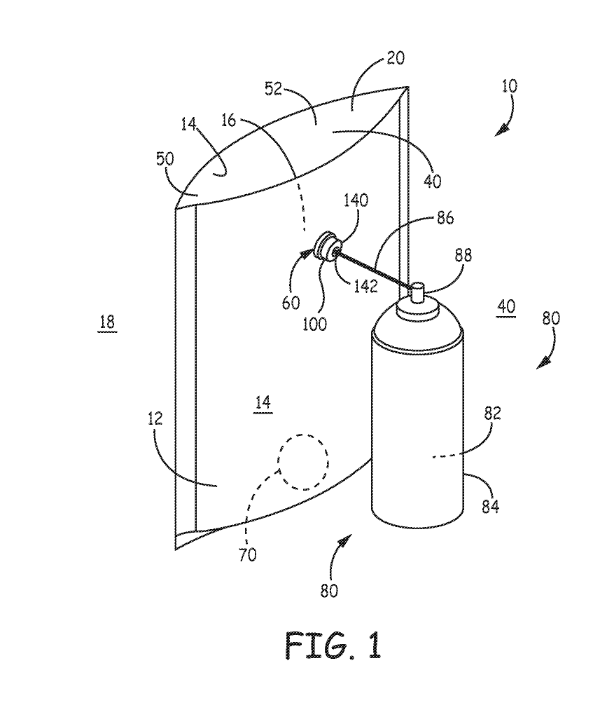

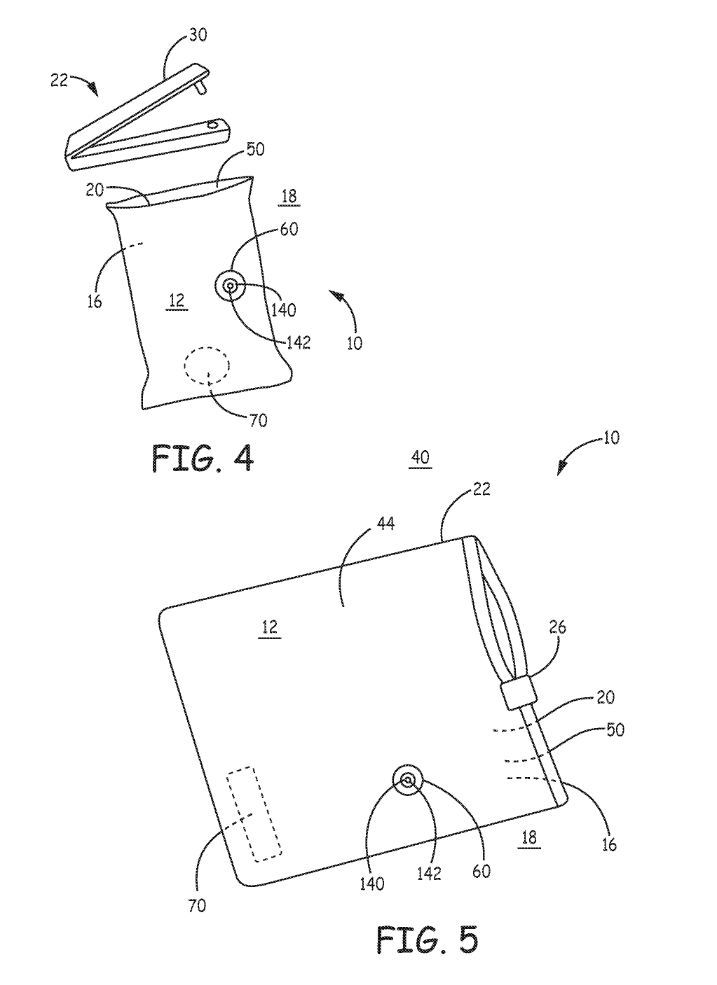

FIG. 1 shows a first embodiment of the reusable modified atmosphere packaging system 10. The system 10 may include a package 12, a closure 22 (FIG. 4), atmospheric gases 40, an exit port 50, an entrance port 60, product 70, and a modified atmospheric source 80. These will be described in serial fashion.

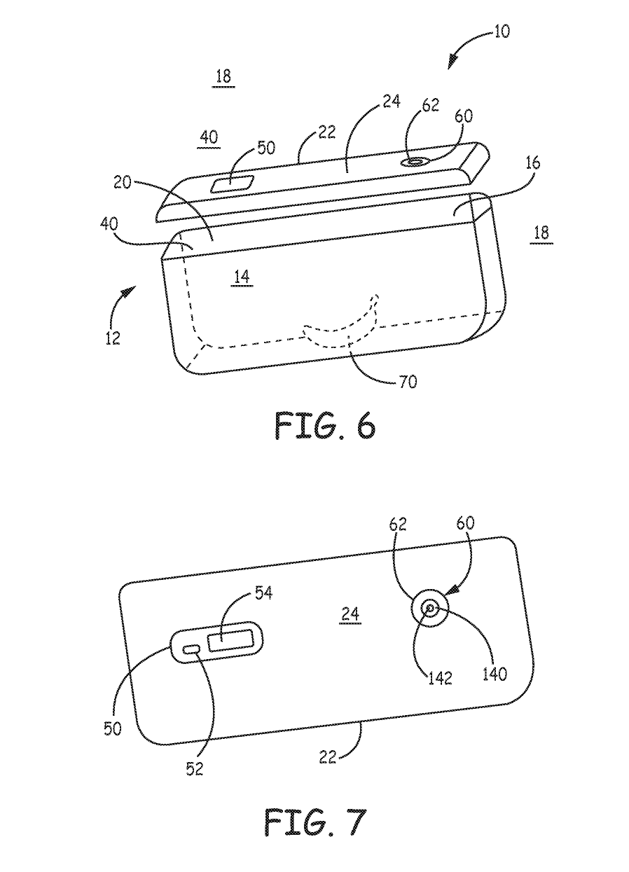

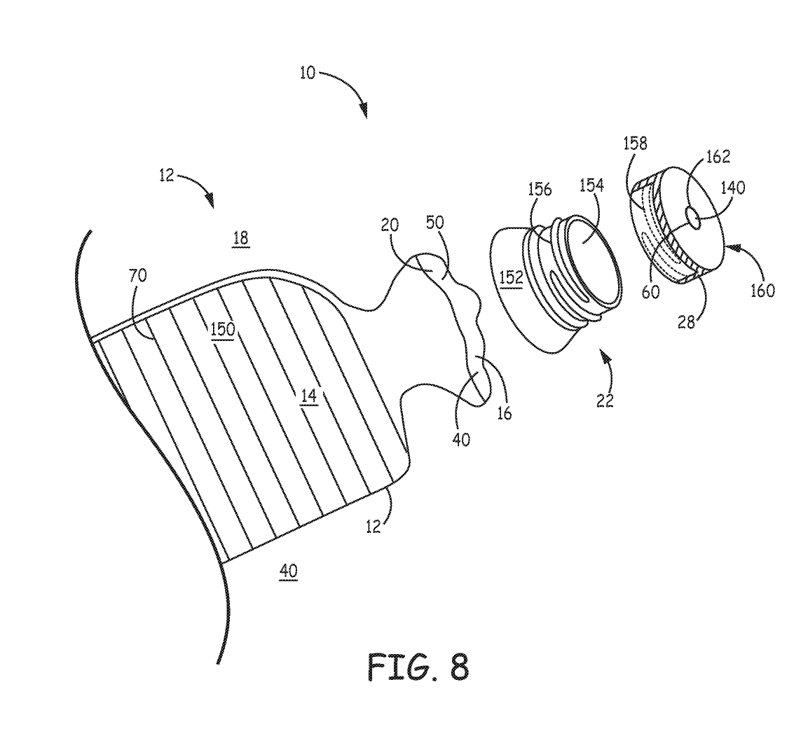

The package 12 may have a plurality of walls 14 that define an interior space 16, an exterior space 18 and an opening 20. The exterior space 18 circumscribes the package 12 and is selectively joinable with the interior space 16. That is, the opening 20 may be open or closed. The package 12 may be a dish (FIGS. 6 and 7), resealable bag (FIG. 5), bag (FIGS. 4 and 8), can, shipping container, tub, box, carton or other such enclosing device.

The closure 22 desirably selectively separates the interior space 16 from the exterior space 18 across the opening 20. The closure 22 has an open position and a closed position. The closure 22 seals the opening 20 when in the closed position and allows access to the product 70 when in the open position. The closure 22 can move back and forth between the open and closed postions. Closures 22, selected for suitability to the type of package 12, may include a lid 24, a zipper lock 26, threaded cap 28 and clip 30.

Atmospheric gases 40, modified atmospheric gases 82, or a blend may be selectively positioned in the interior space 16. Normal atmospheric gases 40 are approximately 78% nitrogen, 20% oxygen, 1% argon, 0.03% carbon dioxide and other elemental and molecular gases. Atmospheric gases 40 enter the interior space 16 upon unsealing of the opening 20. For instance, a user may be placing or removing product 70 from the package 12.

The exit port 50 extends from the interior space 16 to the exterior space 18. The exit port 50 provides a pathway through which atmospheric gases 40 may leave the interior space 16 as modified atmospheric gases 82 enters into the interior space 16. As shown in FIG. 1, the exit port 50 may be at least a portion of the opening 20. The exit port 50 may be a one-way valve or a closable aperture defined by the wall(s) 14. The exit port 50 has an open position, which allows for escape of atmospheric gas 40, during restoration of the modified atmospheric gas 82. The exit port 50 has a closed position, preventing escape of the modified atmospheric gas 82. The exit port 50 can move back and forth between the open and closed postions.

Entrance port 60 extends from the exterior space 18 to the interior space 16. The entrance port 60 provides a pathway through which modified atmospheric gas 82 may enter the interior space 16 in a controlled fashion. To this end, the entrance port 60 desirably is a one-way valve. Various structures for entrance ports 60 are described more fully below.

Product 70 is positioned in the interior space 16. Examples of product 70 include food, beverages, wine, flowers, musical instruments, tobacco, paint, cloth items, circuit boards, electronics, medical equipment, surveying equipment, camera equipment, audiovisual equipment, forensic science materials, soil/plant/animal sample specimens, guns, chemicals, oil based paint, varnish, stain, spackle and joint compound, putty, solvents, mineral spirits, polyurethane, catalysts, photo, printing, furniture refinishing and auto body chemicals, marine coatings, sign paint, chemical compounds, Tung oil, wood fillers, urethane, gunpowder, some glues, epoxy resin, mold making compound, fuel additive, and dyes. Use it on almost anything that evaporates, spoils, dries or oxidizes by reacting with oxygen or moisture or is otherwise advantaged through being positioned in a controlled atmosphere. Modified atmosphere source 80 may contain modified atmospheric gases 82.

The source 80 may be of any size suited to the needs of the consumer. One source 80 may be an aerosol type can 84 joined to a removable straw 86 and push button 88. Push button 88 controls the flow rate of the modified atmospheric gases 82 in the range from no flow to full flow. The modified atmosphere source 80 selectively seals through the entrance port 60. The modified atmospheric gases 82 through push button 88 and straw 86 are in fluid communication with the interior space 16.

Preferably, the modified atmosphere source 80 is a can of pressurized modified atmospheric gas 82. The modified atmospheric gas 82 maybe at least 50% nitrogen with the balance being carbon dioxide. Desirably, the modified atmospheric gas is offered in multiple concentrations of nitrogen, namely 50%, 75% and 100%. Reduction or removal of the oxygen prevents aerobic organisms from growth and reproduction. The pressure inside the can 84 is envisioned to be in the range of 120 PSI at full pressure and accelerants are not part of the gases 82.

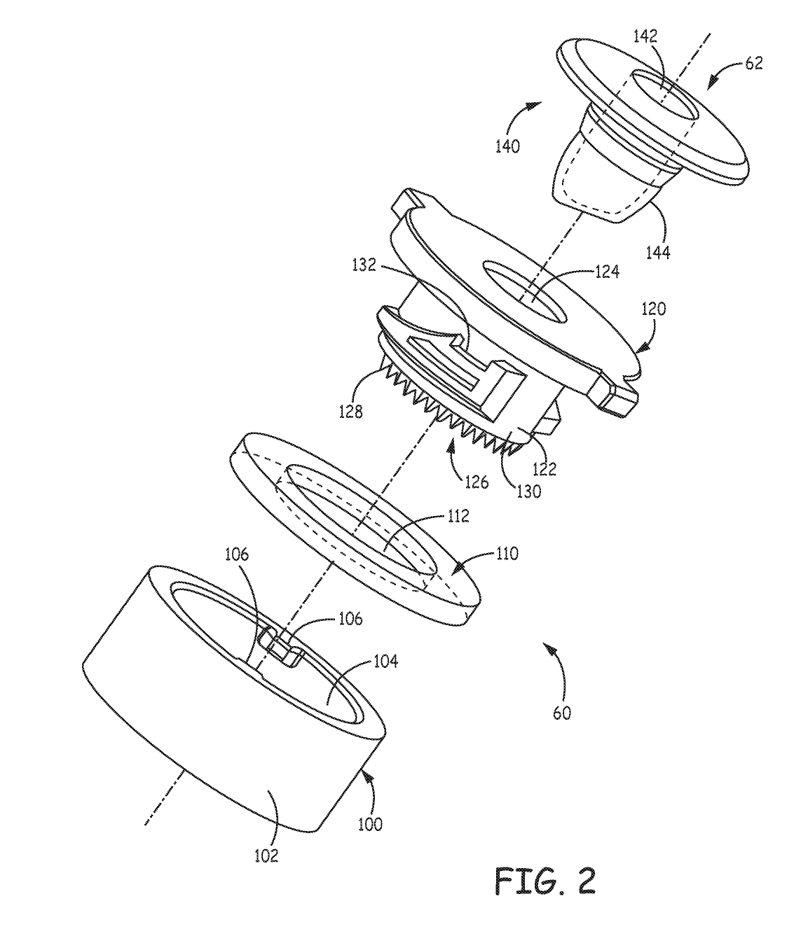

Now referring to FIG. 2, the drawings show a preferred embodiment of the entrance port 60. Entrance port 60 may include an inner member 100, a gasket 110, an outer member 120 and a duckbill 140. Each of these components will be described in serial fashion.

Inner member 100 may have a circumferential wall 102 defining a center aperture 104 therethrough. Installed, the inner member 100 is positioned in the inner space 16 and in part defines the entrance port 60 through a wall 14 of the package 12. Alignment tabs 106, engagable with alignment slots 130 of the outer member 120, may be joined to the circumferential wall 102, extending into the center aperture 104. The alignment tabs 106 may threadably engage with the outer member 120 being received in locking slots 132, fastening the inner member 100 to the outer member 120.

Gasket 110 made be formed of a polymer of high friction co-efficient, such as preferably polypropylene, ABS and/or other. The gasket 110 may provide both a seal and structural structure integrity to the package 12 when the entrance port 60 is secured to the package 12. The gasket 110 may define a center aperture 112 therethrough.

Outer member 120 may have a circumferential wall 122 that extends through the center aperture 112 of the gasket 110 and center aperture 104 of the inner member 100. The inner member 100 is positioned in the interior space 16, the outer member 120 is positioned in the exterior space 18 extending into the interior space 16. The inner member 100 threadedly engages with the outer member 120 with the gasket 110 positioned therebetween. The gasket 110 preferably is positioned in exterior space 18, but could be positioned in the interior space 16.

The outer member 120 defines a center aperture 124. The center apertures 104, 2C) 112, and 124 of the inner member 100, gasket 110 and outer member 120 may be co-axially aligned. The outer member 120, positioned outside the package 12, gasket 110, optionally positioned and inner member 100, positioned inside the package 12 cooperatively define a portion of the entrance port 60.

The outer member 120 may define alignment slots 130. Alignment tabs 106 may be received through the alignment slots 130, aligning the inner member 100 with the outer member 120. Thereafter, a twist of the inner member 100 relative to the outer member 120 positions the alignment tabs 106 into the locking slots 132. The outer member 120 defines the locking slots 132.

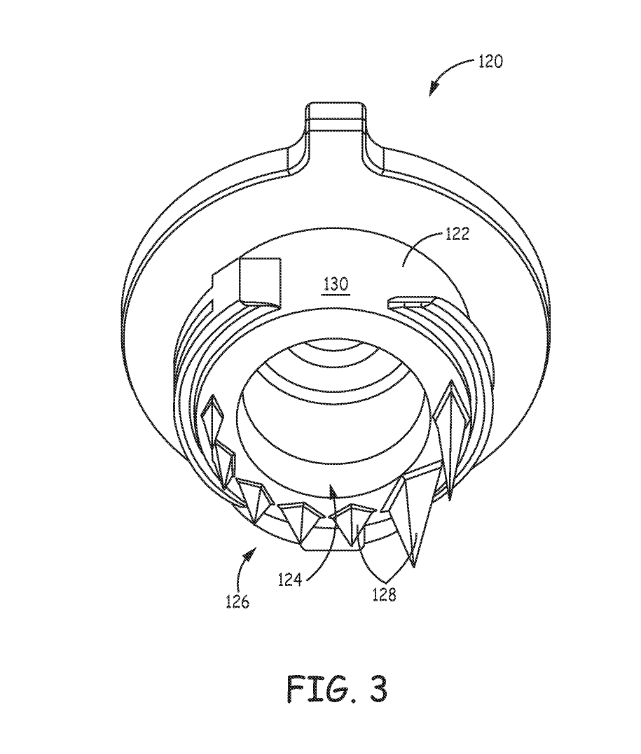

The preferred manner of connection between the inner member 100 and outer member 120 is the twist lock as previously described. The design may optionally use other manners of attachment such as magnetic, adhesive, friction-fit, snap-fit and other fastening mechanisms known in the art. The outer member 120 may have an arc 126 of teeth 128. Alternatively, the arc 126 of teeth 128 may be secured to the inner member 100. The teeth 128 are positioned to puncture the wall 14 of the package 12 when engaging the inner member 100 and outer member 120. For instance, the teeth 128 may be mounted on the circumferential wall 122 of the outer member 120 and oriented into the center aperture 104 of the inner member 100. As shown in FIG. 3, one or more teeth 128 may be of an exaggerated size, e.g., long, relative to the remaining teeth 128, focusing the initial puncture force against the wall 14 of the package 12.

The duckbill check valve 140 is received in the center aperture 124 of and secures to the outer member 120. The attachment may be friction, bonded, snap-fit or other manner of attachment. Duckbill 140 is a one-way valve. The most preferred duck bill 140 is available through Vernay Laboratories, 120 East College Street, Yellow Springs, Ohio 45387. The duckbill 140 is a deformable elastomeric material that readily, selectively and sealably receives the straw 86 of the modified atmospheric source 80 through a center aperture 142. The stem 144 may be extended to enhance the sealed relations between the duck bill 140 and straw 86 and the attachment to the outer member 120.

FIG. 4 shows a clip 30 which may sealably secure to the package 12, sealing the opening 20. Alternatively, a zipper lock 26, as shown in FIG. 5, may seal the opening 20. In both these embodiments, the exit port 50 may be at least a portion of the full opening 20. That is, one may partially cinch the opening 20, substantially closing it, but still allowing some room for the exit of atmospheric gas 40 as the modified atmospheric gas 82 enters the interior space 16.

FIGS. 6 and 7 show a third embodiment of the present invention. The package 12 may be a container such as a microwavable food container with lid 24. The exit port 50 may include an aperture 52 and a slide 54. The slide 54 may have an open position (as shown) where the aperture 52 is uncovered, allowing atmospheric gas 40 to escape. The slide 54 may have a closed position in which the slide 54 seals the aperture 52. The entrance port 60 may be constructed as previously described, although preferably the construct is more simple. For the entrance port 60, the lid 24 may define an aperture 62 and a duckbill check valve 140 may be set in the aperture.

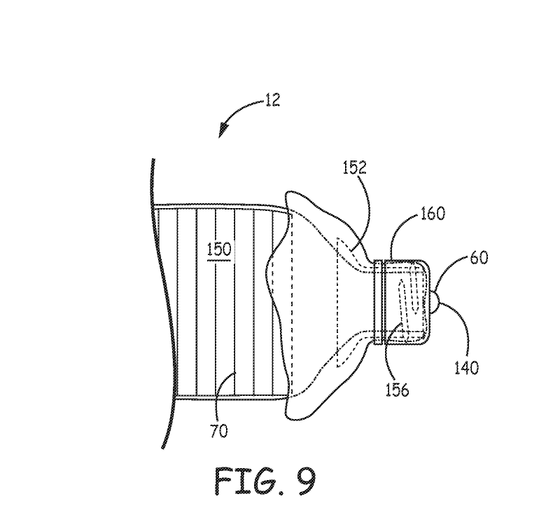

FIGS. 8 and 9 show a fourth embodiment of the present invention. Here, the package 12 may be a bag 150 such as a bag that holds a loaf of bread. The exit port 50 is at least a portion of the opening 20. A collar 152 defines an aperture 154. The open end of the bag 150 may be pushed into the aperture 154 of the collar 152 and thereafter folded back over the collar 152. Threads 156 on the collar 152 mate with threads 158 on the cap 160. That is, the collar 152 threadedly engages the cap 160 with a portion of the bag 150 positioned therebetween as a gasket. The entrance port 60 may be an aperture 162 formed in the cap 160. A duckbill check valve 140 may be inserted into and the aperture 162 and secured to the cap 160. Here, a user, with the bag 150 extending through the aperture 154 of the collar 152, lightly squeezes atmospheric gas 40 out the opening 20 in the bag 150 sufficiently strong to remove the atmospheric gas 40 and sufficiently weak to not harm the product 70. Then the cap 160 is then secured to the collar 152 with the bag 150 trapped therebetween. Modified atmospheric gas 82 may be directed through the entrance port 60 into the bag 150.

In operation, the present invention 10 allows for repeated restoration of a modified atmosphere within packaging. An entrance port 60 is joined to a package 12. The inner member 100, positioned inside the package 12 is engaged with the outer member 120, positioned on the outside of the package 12. A straw 86 or other delivery apparatus, such as a quick release valve and hose attachment, sealably connects a modified atmospheric source 80 with the entrance port 60 and inner space 16. Pressing the push button 88 allows modified atmospheric gas 82 to flow from the modified atmospheric source 80 into the package 12. This flow of gas 82 causes a localized pressure wave that optionally may push atmospheric gas 40 out of the package 12 through the exit port 50. The package 12 is sealed precluding loss of the modified atmospheric gas 82 until a user wishes to access product 70 inside the package 12 through the opening 20. The unsealing allows atmospheric gas 40 back into the package 12. Whereupon, the modified atmospheric gases 82 can be restored inside the package 12 through following the immediately proceeding process.

The present invention has been described with reference to the appended drawings disclosing the best mode of making and using the invention in sufficient detail as to allow one or ordinary skill in the art to make and use the invention. Modifications can be made without departing from the spirit and scope of the present invention.

I claim:

1. A reusable modified atmosphere packaging system, comprising:
a package having a plurality of walls that define an interior space, an exterior space and an opening, the exterior space circumscribing the package, the exterior space being selectively joinable with the interior space,
a closure selectively openable, separating the interior space from the exterior space,
atmospheric gases positioned in the interior space,
an exit port extending from the interior space to the exterior space, the exit port being toggles back and forth between an open position and a closed position,
an entrance port extending from the exterior space to the interior space, the entrance port being a one-way valve,
product positioned in the interior space, and
a modified atmosphere source containing modified atmospheric gases, the modified atmosphere source selectively and repeatedly sealable through the entrance port, the modified atmospheric gases selectively in fluid communication with the interior space.

2. The device of claim 1 wherein the package is a member selected from the group consisting of dish, resealable bag, bag, can, carton, tub, box and shipping container.

3. The device of claim 1 wherein the closure is a member selected from the group consisting of lid, zipper lock, threaded cap and clip.

4. The device of claim 1 wherein the exit port is at least a portion of the opening.

5. The device of claim 1 wherein the exit port is one-way valve.

6. The device of claim 1 wherein the exit port is a closable aperture defined by the wall.

7. The device of claim 1 wherein the product is a member of the group consisting of food, flowers, musical instruments, tobacco, cloth items and paint.

8. The device of claim 1 wherein the modified atmosphere source is a can of pressurized modified atmosphere.

9. The device of claim 1 wherein the modified atmosphere in the modified atmosphere source is at least 50% nitrogen.

10. The device of claim 1 wherein the modified atmosphere in the modified atmosphere source is 100% nitrogen.

11. The device of claim 1, the entrance port further comprising:
an inner member, the inner member having a circumferential wall defining a center aperture therethrough,
a gasket having a center aperture defined therethrough,
an outer member, the outer member having a circumferential wall extending through the center aperture of the gasket and threadedly engaging the inner member, the outer member defining a center aperture, the center apertures of the inner member, gasket and outer member being co-axially aligned, the outer member having an arc of teeth, the teeth mounted on the circumferential wall of the outer member and oriented into the center aperture of the inner member, and
a duckbill frictionally received in the center aperture of the outer member, the duck bill being a one-way valve.

12. The device of claim 11, further comprising:
alignment tabs mounted on the inner member, and
alignment slots defined in the outer member, the alignment tabs being received through the alignment slots, aligning the inner member with the outer member.

13. The device of claim 12 wherein the alignment tabs threadedly engage the outer member.

14. The device of claim 12 wherein the alignment tabs are positioned in locking slots defined by the outer member.

15. The device of claim 11 wherein the duckbill is snap-fit into the outer member.

16. The device of claim 11 wherein the teeth comprise short teeth and long teeth.

17. The device of claim 16 having a plurality of long teeth.

18. The device of claim 11 wherein the teeth are positioned to pierce the package when engaging the inner and outer members.

19. The device of claim 11 wherein the inner member is positioned in the interior space, the outer member is positioned in the exterior space and the inner member is threadedly engaged with the outer member with the gasket positioned therebetween.

20. An entrance port, comprising:
an inner member, the inner member having a circumferential wall defining a center aperture therethrough,
a gasket having a center aperture defined therethrough,
an outer member, the outer member having a circumferential wall extending through the center aperture of the gasket and threadedly engaging the inner member, the outer member defining a center aperture, the center apertures of the inner member, gasket and outer member being co-axially aligned, the outer member having an arc of teeth, the teeth mounted on the circumferential wall of the outer member and oriented into the center aperture of the inner member, and
a duckbill frictionally secured in the center aperture of the outer member, the duckbill being a one-way valve.
